(19) United States
(12) Patent Application Publication
(10) Pub. No.: US 2026/0206101 A1
(43) Pub. Date: Jul. 16, 2026

(54) Electric heated pillow

(71) Applicant: Rong Chen, Corona Del Mar, CA (US)

(72) Inventor: Rong Chen, Corona Del Mar, CA (US)

(21) Appl. No.: 19/019,109

(22) Filed: Jan. 13, 2025

(51) Int. Cl. H05B 3/34

(52) U.S. Cl. CPC H05B 3/342; H05B 2203/011

(57) ABSTRACT

An electric heated pillow having a pillow case wrapping a plurality of interior layers that include a bendable, very thin and low voltage resistance heat film wrapped between two or more layers of sponge stacked on a layer of soft pillow stuffing, a cable, and a temperature controller. The heat film is supplied with a plurality of gaps in order to allow it to flex to match the shape and softness of the pillow. The temperature controller connects to the heat film through a cable with power and temperature sensor wires. The temperature controller contains a printed circuit board with an embedded program in the microcontroller, that offers multiple features. The general purpose of the present electric heated pillow is to supply both warmth and comfort and can heat various parts of the human body, including but not limited to the knee, abdomen, and lower back.

### CROSS-REFERENCE TO RELATED APPLICATIONS

Not Applicable

### FEDERALLY SPONSORED RESEARCH OR DEVELOPMENT

Not Applicable

### NCORPORATION BY REFERENCE OF MATERIAL SUBMITTED ON A COMPACT DISK

Not Applicable

### BACKGROUND OF THE INVENTION

A soft electric heated pillow that contains a low voltage resistance heat film with a plurality of gaps in order to allow it to flex to match the shape and softness of the pillow, a cable and a temperature controller to maintain the stable heated temperature of the electric heated pillow. The electric heated pillow can be used to heat various parts of the human body, including but not limited to the knee, abdomen, and lower back.

### FIELD OF THE INVENTION

This invention relates to an electric heated pillow that contains a low voltage resistance heat film with a plurality of gaps in order to allow it to flex to match the shape and softness of the pillow, a cable and a temperature controller to maintain the stable heated temperature of the electric heated pillow.

### SUMMARY OF THE INVENTION

The general purpose of the present electric heated pillow, described subsequently in greater detail, is to provide a soft electric heated pillow that supplies both warmth and comfort and can heat various parts of the human body, including but not limited to the knee, abdomen, and lower back.

To accomplish this the electric heated pillow comprises a pillowcase wrapping a plurality of interior layers, a cable and a temperature controller. The interior layers are a bendable very thin low voltage resistance heat film wrapped between two or more layers of sponge stacked on a layer of soft pillow stuffing that is more than 2-inches thick. It may or may not contain fabric layer and/or stuffing layer in between sponge layers. In order to allow the heat film to flex to match the shape and softness of the pillow stuffing, the heat film is supplied with a plurality of gaps. The heat film is a similar shape and size to the pillowcase. The heat film contains an iron-chromium-aluminum alloy etching heating layer pressed between two layers of polyester film. The heat film generates a certain amount of heat when an electric current is supplied. One side of the heat film wrapped between two or more layers of sponges attaches to the top side of the pillowcase with the mark on its surface. The mark may be placed anywhere on the top side of pillowcase. The mark may be a logo or sign. The other side of the heat film wrapped between two or more layers of sponge stacks on a layer of soft pillow stuffing and then attaches to the bottom side of the pillowcase without the mark on its surface. The bottom side of the pillow without the mark heats more slowly than the top side with the mark on its surface due to the thickness and heat conductivity of the pillow stuffing. This allows the user to select which electric heated pillow side to place on the desired part of their body. The sponge and pillow stuffing layers maintain the heat and supply a gentle heat experience to the user.

A cable including power wires and temperature sensor wires is attached to the heat film. The power wires supply electric current to the heat film. The temperature sensor wires attach to a temperature sensor. The temperature sensor attaches to the surface of the heat film to measure the temperature of the heat film. Power wires and temperature sensor wires are included in one cable extending from the pillow to a temperature controller. There is an opening in the pillow to allow the cable to extend from the heat film to the outside of the pillow. The temperature controller contains a printed circuit board with an embedded program in the Microcontroller. The temperature controller offers features including but not limited to, supplying electric current to the heat film, turning on or off the electric current to the heat film, reading the temperature from the temperature sensor, selecting among multiple heating modes that supply different heating temperatures, and controlling the heat film temperature to a certain temperature. The main feature of the temperature controller is using the embedded program to control the heat film at a certain temperature by turning on or off the electric current supply to the heat film based on the temperature read from the temperature sensor. The temperature controller controls the electric heated pillow at a stable heated temperature. The temperature controller is powered by a direct current power adapter or a rechargeable battery.

The electric heated pillow is flexible and can be used on various parts of the human body, including but not limited to the knee, abdomen, and lower back.

### BRIEF DESCRIPTION OF THE DRAWINGS

### Figures

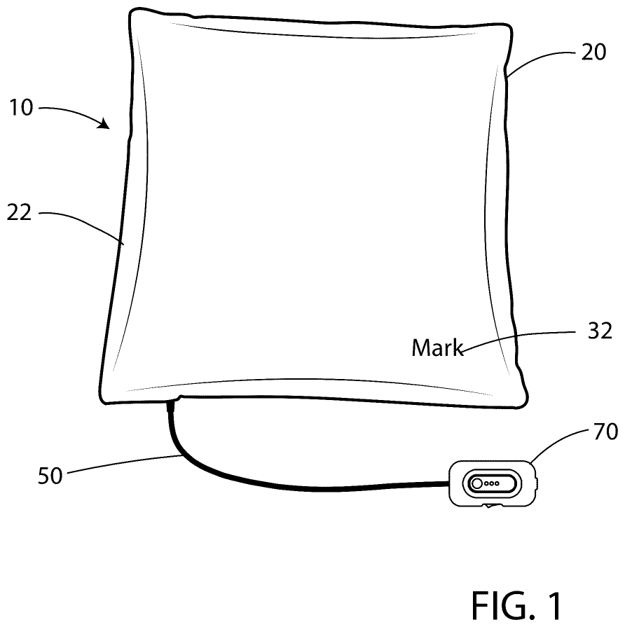

FIG. 1 is a perspective view of the electric heated pillow.

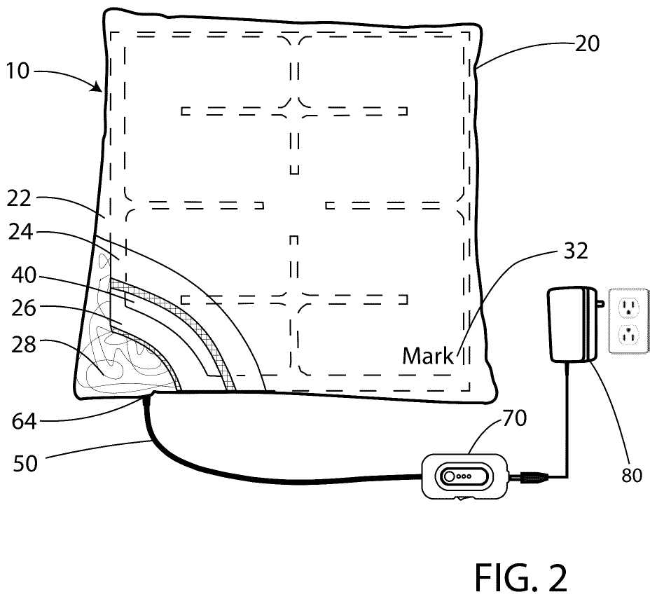

FIG. 2 is a top plan view of the pillow, partially broken away to show all the layers.

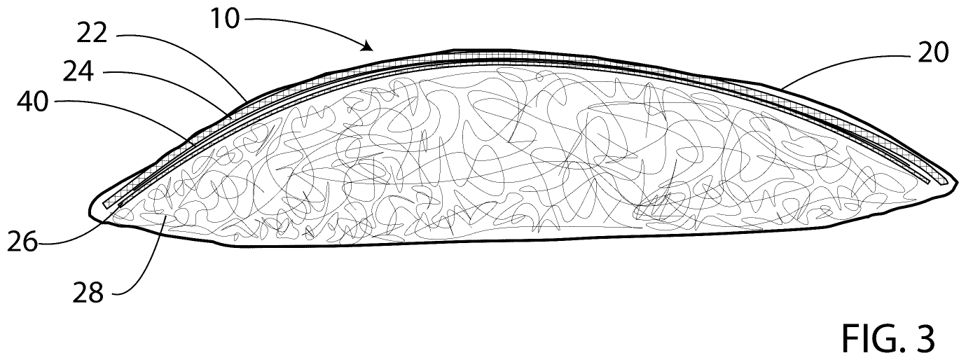

FIG. 3 is a side plan view, broken away to show all the layers.

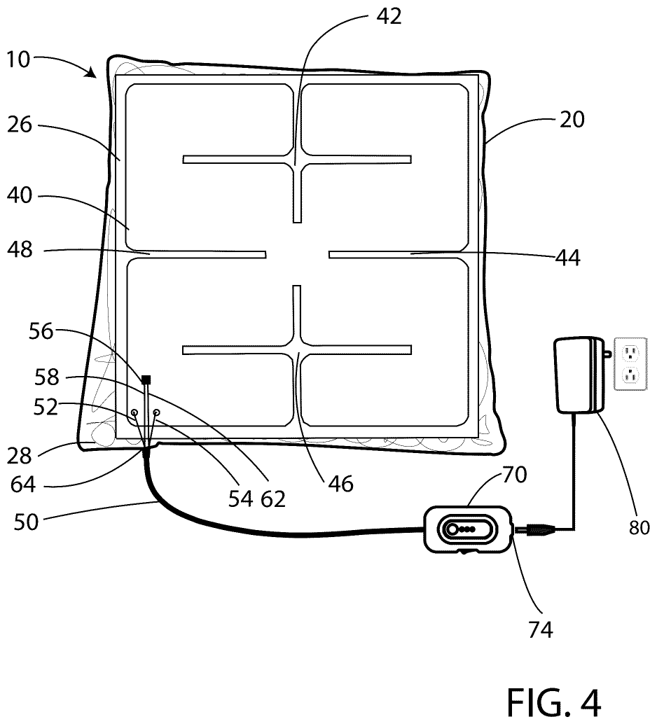

FIG. 4 is a top plan view of the pillow, broken away to the heat film layer to show the details of the heat film.

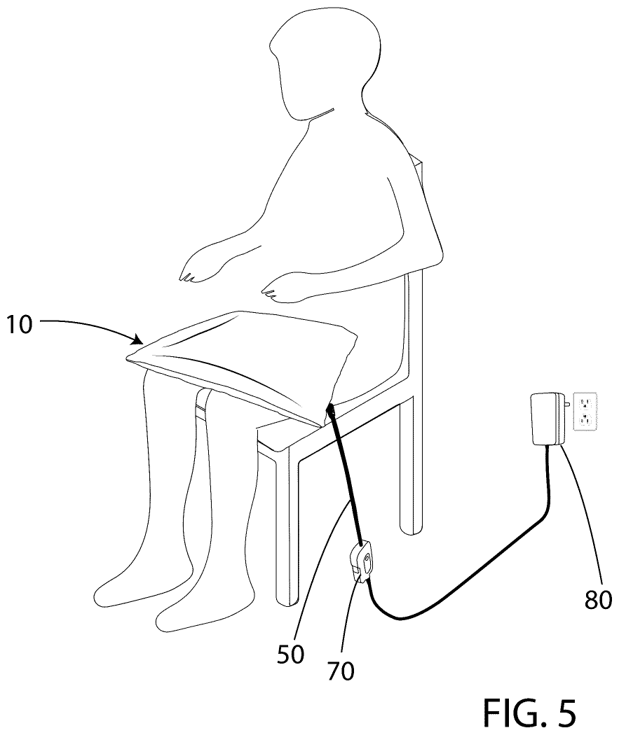

FIG. 5-7 are in-use views.

### DETAILED DESCRIPTION OF THE DRAWINGS

With reference now to the drawings, and in particular FIGS. 1 through 7 thereof, an example of the electric heated pillow employing the principles and concepts of the present electric heated pillow and generally designated by the reference number 10 will be described.

Referring to FIGS. 1 through 7, the electric heated pillow 10 is illustrated. As shown in FIG. 1, the electric heated pillow 10 comprises a pillow 20, a cable 50 and a temperature controller 70. As shown in FIG. 2 and FIG. 3, the pillow 20 comprises a plurality of interior layers from top to bottom including a sponge layer 24, a thin heat film 40, a sponge layer 26, and soft stuffing 28 wrapped in a pillowcase 22. It may or may not contain fabric layer and/or stuffing layer in between sponge layers 24 and 26.

Referring to FIG. 4, the low voltage resistance heat film 40 is very thin (<0.25 mm) and bendable. The flexible heat film 40 is supplied with a plurality of gaps 42, 44, 46, 48, or other shapes of gaps in order to allow it to flex to match the shape and softness of the pillow 20 and maintain the softness and comfort of the pillow 20. The cable 50 contains power wires 52, 54 and thermal sensor wires 58, 62. The power wires 52, 54 connect to the heat film 40 and supply current to the heat film 40. The thermal sensor wires 58, 62 connect to a thermal sensor 56, and the thermal sensor 56 attaches to the heat film 40 to measure the temperature of the heat film 40. There is an opening 64 in the pillow 20 to allow the cable 50 to extend from the heat film 40 to the outside of the pillow 20. The cable 50 connects to the temperature controller 70. The temperature controller 70 contains a printed circuit board with an embedded program in the microcontroller, that offers features including but not limited to, supplying electric current to the heat film 40, turning on or off the electric current to the heat film 40, reading the temperature from the temperature sensor 56, selecting among multiple heating modes that supply different heating temperatures, and controlling the heat film 40 temperature to a certain temperature. The temperature controller 70 is powered by a DC power adapter 80 or a rechargeable battery pack.

Refer to FIG. 2, the heat film 40 is a similar size to the pillowcase 22. The heat film 40 contains an iron-chromium-aluminum alloy etching heating layer pressed between two layers of polyester film. When the power current flows through the alloy layer, the current generates a certain amount of heat. The heat is transmitted from the heat film 40 to the sponge layer 24 and then to the top side of the pillowcase 22 with the mark 32 on its surface. The mark 32 may be placed anywhere on the top side of pillowcase 22. The mark 32 may be a logo or sign. The mark 32 indicates the faster heat side of the electric heated pillow 10. The heat is transmitted from the heat film 40 to the sponge layer 26, then to the pillow stuffing 28, then to the bottom side of the pillowcase 22 without the mark 32 on its surface. The bottom side without mark 32 on its surface is heated more slowly and to a lower temperature compared to the top side of the pillow with the mark 32 on its surface due to the thickness and heat conductivity of the pillow stuffing 28.

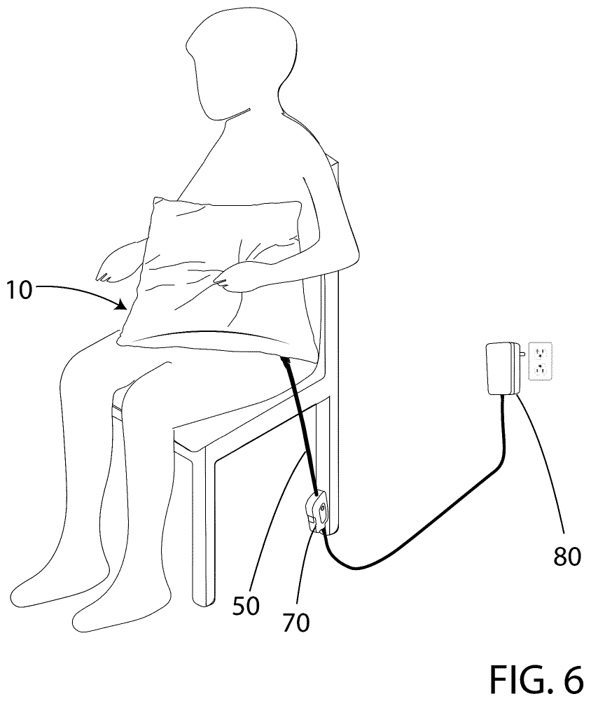

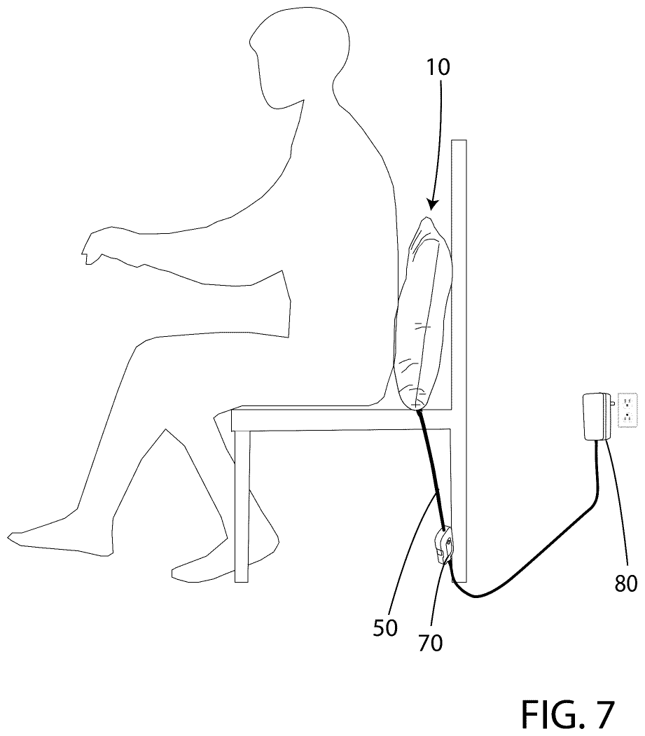

The electric heated pillow 10 can be used to heat various parts of the human body. As shown in FIG. 5, the electric heated pillow 10 heats the knee of the human body. As shown in FIG. 6, the electric heated pillow 10 heats the abdomen of the human body. As shown in FIG. 7, the electric heated pillow 10 heats the lower back of the human body.

What is claimed is:

1. An electric heated pillow comprising:
a) A plurality of interior layers including a bendable very thin low voltage resistance heat film that is supplied with a plurality of gaps wrapped between two or more layers of sponge stacked on a layer of soft pillow stuffing;
b) A pillowcase that encloses a plurality of interior layers described in a);
c) A cable that contains power and temperature sensor wires and connects the heat film to the temperature controller;
d) A temperature controller that contains a printed circuit board with an embedded program in the microcontroller, that offers features including but not limited to supplying electric current to the heat film, turning on or off the electric current to the heat film, reading the temperature from the temperature sensor, selecting among multiple heating modes that supply different heating temperatures, and controlling the heat film temperature to a certain configured temperature.

2. The low voltage resistance heat film supplied with gaps in order to allow it to flex to match the shape and softness of the pillow.
